(19) United States
(12) Patent Application Publication
(10) Pub. No.: US 2015/0162179 A1
(43) Pub. Date: Jun. 11, 2015

(54) METHOD OF CALIBRATING A SYSTEM COMPRISING A GAS-DISCHARGE LAMP AND A COOLING ARRANGEMENT

(71) Applicant: KONINKLIJKE PHILIPS N.V., EINDHOVEN (NL)

(72) Inventors: Ger Van Hees, Vosselaar (BE); John-John Pietter Jan Van Den Bergh, Turnhout (BE); Christian Hackmann, Mortsel (BE); Kristin Annemie Dirk Gysels, Wilruk (BE)

(21) Appl. No.: 14/360,456

(22) PCT Filed: Nov. 26, 2012
(86) PCT No.: PCT/IB2012/056731

§ 371 Date: May 23, 2014

Related U.S. Application Data
(60) Provisional application No. 61/564,323, filed on Nov. 29, 2011.

(51) Int. Cl. H01J 61/52; H01J 61/82; G03B 21/16; H05B 41/14

(52) U.S. Cl. CPC H01J 61/52; H05B 41/14; H01J 61/82; G03B 21/16

(57) ABSTRACT

The invention describes a method of generating calibration data (ΔUₓ, CPₓ) for a system (3) comprising a gas-discharge lamp (1) and a cooling arrangement (2) for cooling the lamp (1), which method comprises the steps of establishing a correlation (R_{P-U}) between a lamp operating parameter delta (ΔU) and a lamp cooling status parameter delta (ΔP, ΔB); and associating a cooling arrangement control parameter (CP, CPₓ) with a lamp operating parameter delta (ΔU) on the basis of the established correlation (R_{P-U}). The invention also describes a method of calibrating a cooling arrangement (2) of a system (3) comprising a gas-discharge lamp (1) and a cooling arrangement (2) for cooling the lamp (1). The invention also describes a method of controlling a cooling arrangement (2) in a system (3) comprising a high-pressure gas discharge lamp (1). The invention further describes a system (3) comprising a high-pressure gas discharge lamp (1); a cooling arrangement (2) for cooling the lamp (1), which cooling arrangement (2) is calibrated using the calibration method according to the invention; and a cooling arrangement controller (33) for controlling the cooling arrangement (2) using the control method according to the invention.

### FIELD OF THE INVENTION

The invention describes a method of generating calibration data for a system comprising a gas-discharge lamp and a cooling arrangement; a method of calibrating a cooling arrangement of such a system; and a method of controlling a cooling arrangement in such a system. The invention also describes a system comprising a gas discharge lamp and a cooling arrangement.

### BACKGROUND OF THE INVENTION

Gas-discharge lamps such as high-pressure or ultra-high-pressure (UHP) lamps are used in applications requiring a point-like source of very bright light. For example, a UHP lamp can be used as the light source of a projector. During operation, such a lamp becomes very hot and must be cooled, usually by directing a cooling airflow over the lamp and/or adjusting the lamp current, etc. Owing to convection, the temperature in an upper region of the discharge vessel of the lamp will be hotter than in a lower region. However, it is generally quite difficult to determine the cooling status of a high pressure lamp with any accuracy. Typically, in the design stage of the application, some temperature measurements are performed to check the cooling level of the lamp being used. The aim of the temperature measurements is to determine optimum conditions for the lamp in that application. For example, an optimal cooling condition can require that the temperature at the hottest part of the discharge vessel of the lamp should not exceed a certain value, since temperatures in excess of this maximum can result in quartz crystallization. Another condition can require that the temperature in the interior of a discharge vessel of the lamp does not drop below a certain minimum, in order to avoid mercury condensation, particularly in the “coldest spot” region of the discharge vessel. Generally, a temperature in the discharge vessel that is too high or too low can lead to an early failure of the lamp.

Known monitoring methods are used to estimate the temperatures in different parts of the discharge vessel. For example, the hottest and coldest temperatures can be estimated in a calibration phase by measuring the temperature of the outside of the arc tubes of lamps of a test series, for different lamp power levels or lamp voltage levels. The lamp manufacturer can then specify maximum and minimum temperature values, and the application (for example a projection system) must ensure that these specifications are complied with in order to ensure a favourably long lifetime for the lamp being used.

The temperature measurements generally require the use of modified application equipment, test lamp setups, and dedicated measuring equipment. For example, the temperatures can be measured using thermocouples attached to a lamp of a test series. Another method involves making one or more holes in a reflector in which the lamp is mounted, and using an infrared camera arranged in front of a hole to measure the temperature. The temperatures measured using the known methods are usually inaccurate to some degree, since the test environment is of necessity different from a real-life environment. Therefore, any cooling control algorithm based only on these temperature measurements generally results in a less-than-optimal cooling. Particularly for UHP lamps, a long lifetime with consistently good light output is of great importance. However, non-optimal cooling generally shortens the achievable lifetime of such a lamp.

Therefore, it is an object of the invention to provide an improved way of cooling a gas-discharge lamp.

### SUMMARY OF THE INVENTION

The object of the invention is achieved by the method according to claim 1 of generating calibration data for a system comprising a high-pressure gas-discharge lamp and a cooling arrangement for cooling the lamp; by the method of claim 10 of calibrating a cooling arrangement of such a system; by the method of claim 11 of controlling a cooling arrangement in such a system; and by the system of claim 13.

According to the invention, the method of calibrating a system comprising a high-pressure gas-discharge lamp and a cooling arrangement for cooling the lamp comprises the steps of establishing a correlation or dependency between a lamp operating parameter delta and a lamp cooling status parameter delta; and associating a cooling arrangement control parameter with a lamp operating parameter delta on the basis of the established correlation.

An advantage of the method of generating calibration data according to the invention is that it makes it possible to deduce the status of the cooling in the lamp simply by monitoring a change or “delta” in a lamp operating parameter under controlled operating conditions. In the following, the term “delta” is used in this context, i.e. to mean the difference between a first and a second monitored value. The novel approach afforded by the method according to the invention is less complicated and also more accurate than the known methods described in the introduction. The method of generating calibration data according to the invention therefore offers an improved way of optimising, during the design phase of the system, the performance of the cooling arrangement of the lamp.

According to the invention, the method of calibrating a cooling arrangement of a system comprising a gas-discharge lamp and a cooling arrangement for cooling the lamp comprises the steps of determining a number of lamp operating parameter deltas and associated cooling arrangement control parameters for that lamp using the method of generating calibration data according to the invention, and storing the lamp operating parameter deltas and associated cooling arrangement control parameters in a memory accessible to the cooling arrangement. According to the invention, the method of controlling a cooling arrangement in a system comprising a high-pressure gas discharge lamp, which cooling arrangement is calibrated using the calibration method according to the invention, comprises the steps of monitoring a lamp operating parameter during operation of the lamp at a first cooling level; reducing or interrupting the cooling and subsequently measuring a lamp operating parameter change; retrieving a control parameter for the cooling arrangement associated with the lamp operating parameter delta, and controlling the cooling arrangement according to the control parameter.

An advantage of the control method according to the invention is that it can be applied to the lamp during its operational use, i.e. not just in a test or calibration setup, so that the cooling can be adjusted on-the-fly, as necessary, without requiring any additional or dedicated measuring devices. An example of a corrective action might be to generate a control parameter to adjust the lamp power. In a system that uses a fan to direct a cooling airflow over the lamp, the corrective action might be to adjust the cooling fan settings. The control method according to the invention allows control parameters to be generated as necessary, so that optimal operating conditions can be maintained as the need arises. Using the control method according to the invention, an optimal cooling can be determined for any “atypical” situation, i.e. a situation that differs from the “typical” situation for which the system is intended. For example, a system designed for use under normal atmospheric conditions might be used in a high-altitude location with low atmospheric pressure; a system designed for use in normal ambient conditions may be used instead in a very dusty location with the result that the cooling air filters become saturated sooner than expected, etc. Equally, a system in which the lamp is already considerably older than its expected lifetime might still be operational with that lamp. The control method according to the invention makes it possible to determine the cooling status of a lamp—during operation—without requiring any additional measuring setup or dedicated equipment. Also, since the method according to the invention allows the operating conditions of a lamp to be determined in an unaltered system environment, it also allows an “in-line” testing of any system comprising a lamp and cooling arrangement. This makes it easier for a manufacturer to provide systems with perform optimally under any operating condition.

According to the invention, a system comprises a high-pressure gas discharge lamp; a driver for driving the lamp; a cooling arrangement for cooling the lamp, which cooling arrangement is calibrated using the method of generating calibration data according to the invention; and a cooling arrangement controller for controlling the cooling arrangement using the control method according to the invention.

The dependent claims and the following description disclose particularly advantageous embodiments and features of the invention. Features of the embodiments may be combined as appropriate. Features described in the context of one claim category can apply equally to another claim category.

In the following, without restricting the invention in any way, the gas-discharge lamp may be assumed to be a high-pressure gas-discharge lamp, in particular an ultra-high-pressure (UHP) gas-discharge lamp. Furthermore, again without restricting the invention in any way, the system may be assumed to comprise a projection system, in which the lamp serves to provide a near point-like source of light, usually white.

The method of generating calibration data according to the invention is preferably carried out for several lamps of a lamp series, so that a favourable accuracy of the calibration can be obtained. The method of generating calibration data can involve the monitoring of any suitable lamp operating parameter, e.g. lamp current. However, in a particularly preferred embodiment of the invention, the lamp operating parameter comprises the lamp voltage, since the lamp voltage is a good indicator of conditions in the lamp and is usually already monitored by the system's lamp driver, so that there may be no need for an additional voltage measuring means, and any required lamp voltage values can simply be obtained directly from the lamp driver.

When a mercury-vapour gas-discharge lamp is being operated, the proportion of mercury that is in a vapour state is indicative of the environment in the lamp, and is also related to the quality of the light output of the lamp. For example, if much of the mercury is in vapour form, then a correspondingly greater fraction of the halide can be in vapour form, so that the chemical cycle can function well. On the other hand, if some of the mercury has condensed owing to a “too cool” environment in the lamp, then a corresponding fraction of the halide will dissolve in the liquid mercury. This dissolved halide is no longer available to the chemical cycle, and the quality of the light output by the lamp is less than optimal. Prior art techniques of determining optimal cooling conditions or thermal specifications for a lamp involve monitoring the temperature at the “coldest spot” in the lamp, since this can be an indication of the state of the chemical cycle in the discharge vessel. However, the temperature cannot always be measured with a reliable accuracy, and the information collected in this way cannot be used to derive a practicable control algorithm for a cooling arrangement during normal operation of the lamp. Therefore, a particularly preferred embodiment of the invention comprises the step of establishing a relationship between a lamp cooling status parameter—other than temperature—and the lamp cooling status, wherein the step of associating a cooling arrangement control parameter with a lamp operating parameter delta is performed on the basis of the established relationship. In this way, the cooling status of the lamp can be related to a parameter independent of a temperature of the lamp.

The lamp cooling status parameter can be any suitable parameter, preferably a parameter that can be accurately and reliably measured using an appropriate measuring technique. In one preferred embodiment of the invention, the lamp cooling status parameter comprises a spectroscopic pressure measurement relating to a pressure in the interior of a discharge vessel of the lamp. Thus, a relationship between a lamp operating parameter and a pressure can be established.

Preferably, the halide in the lamp is mercury bromide, since bromine is usually used in such a gas-discharge lamp to prevent evaporated tungsten (from the electrodes) from being deposited on the interior wall of the discharge vessel. During calibration in this embodiment of the invention, the lamp pressure is monitored. Any suitable technique can be used for this monitoring. However, a reliable method is given by spectroscopy, since the momentary lamp environment can be directly inferred from line widths of the spectroscopic results. For example, the mercury radiation line width can be analysed to determine the mercury pressure inside the lamp at any given instant with satisfactory accuracy. The same applies to a radiation line width of the halide being monitored.

The “halide concentration” is to be understood as the measured concentration of a halide in vapour form, i.e. how much of the halide of the lamp fill is available in vapour form to the chemical cycle. As mentioned above, if conditions in the lamp are relatively “cool”, much of the halide will have dissolved in the condensed mercury and is therefore no longer available to the chemical cycle, and in a “hot” lamp, most or all of the halide will be available in vapour form. Therefore, a direct relationship can be established between the halide concentration and the change in lamp pressure.

The relationship is preferably established by operating the lamp in an unsaturated state, i.e. at a highest or maximum achievable lamp pressure to ensure that essentially all the mercury is in vapour form (and that essentially all the halide is in vapour form), and subsequently cooling the lamp while continually obtaining measurements of the lamp pressure and the halide concentration until the halide is essentially entirely condensed or dissolved in the liquid mercury, so that the pressure/halide relationship can be established. An optimum halide concentration (or optimum halide concentration range) for a particular lamp type can be identified, and is associated with an operating condition in which the lamp environment is hot enough to ensure a functioning chemical cycle, but not so hot as to result in damage to the quartz glass.

In another preferred embodiment of the invention, the lamp cooling status parameter comprises a value or measurement quantifying an extent of discoloration on the interior of a discharge vessel of the lamp. Thus, a relationship between a lamp operating parameter and a blackening value can be established.

During calibration in this embodiment of the invention, the extent of blackening is monitored. Again, any suitable technique can be used to measure or quantify the amount of the tungsten deposited on the inside walls of the discharge vessel, and/or the rate at which it is deposited.

Again, this relationship is preferably established by operating the lamp in an unsaturated state, i.e. at a highest or maximum achievable lamp pressure to ensure that essentially no tungsten is deposited on the discharge vessel walls, and subsequently incrementally increasing the cooling of the lamp while continually observing the discharge vessel wall to detect the onset of blackening and the amount of blackening. The measured extent of blackening is then used to directly relate the cooling status of the lamp to the change in lamp operating parameter delta, for example lamp voltage.

These relationships can be established during the calibration procedure. Preferably, these relationships are established at the outset of calibration.

The inventors recognized that such an established relationship can be used to deduce or infer the cooling status in the lamp during normal operation of the lamp, and that this relationship can be used during normal operation of the lamp in a situation in which the lamp pressure is caused to rise in a controlled manner. Therefore, in a preferred embodiment of the method of generating calibration data according to the invention, the correlation between a lamp voltage delta and a lamp cooling status parameter delta is determined during operation of the lamp at a specific cooling condition. This specific cooling condition is one that can be repeated during normal operation of the lamp also. In a particularly preferred embodiment of the invention, the specific cooling condition comprises a reduction, preferably a cessation of lamp cooling. By turning off the cooling, the temperature in the lamp will rise, and the lamp pressure will increase. This is reflected in an increase in lamp voltage. For example, if the lamp voltage delta has been correlated to the lamp pressure delta, a certain measured lamp voltage delta can be used to deduce the corresponding lamp pressure delta. This lamp pressure delta, in turn, reveals the halide concentration. Therefore, the lamp voltage delta can be used to deduce whether the lamp was being cooled too much, correctly, or not enough before the cooling was turned off. The cooling arrangement can respond, if necessary, by increasing or decreasing the cooling as appropriate.

The rise in temperature and pressure after turning off the lamp cooling should not be allowed to persist, since damage to the lamp could result. Therefore, in a further preferred embodiment of the invention, the lamp voltage delta is measured when a predefined time has elapsed after reduction or cessation of the lamp cooling. The predefined time span comprises preferably at most 60 s, more preferably at most 40 s, most preferably at most 20 s. By performing the “cooling check” in such a short period of time, the process of determining whether the lamp is in fact being correctly cooled will not noticeably interfere with the performance of the system. Therefore, the “cooling check” can be carried out at any time during normal performance of the lamp.

The knowledge obtained by the method of generating calibration data can be used during normal operation of the system. To this end, the calibration method according to the invention allows the cooling arrangement of a system to be configured using information collected for the lamp type to be used in that system, by storing the lamp operating parameter deltas and associated cooling arrangement control parameters in a memory accessible to the cooling arrangement, for example a memory of the lamp driver or a dedicated memory for a cooling arrangement controller of that cooling arrangement. For example, during calibration, lamp voltage deltas of −0.5V, −1.5V, −3.0V are linked to temperatures of +40°, ±0°, and −40° respectively relative to a desired coldest spot temperature. A lamp voltage delta of about −1.5V (measured after a certain time span) would then indicate that the lamp cooling was alright. A lamp voltage delta of only about −0.5V would indicate that the lamp cooling was insufficient, since the lamp is too hot, and the cooling is therefore increased accordingly. A lamp voltage delta of more than about −3.0V would indicate that the lamp was being cooled too much, and the cooling is therefore decreased accordingly. The lamp voltage deltas can be associated with specific control parameters, depending on the type of cooling arrangement being used. For example, a certain lamp voltage delta could be associated with a certain increase or decrease in fan speed rpm for a cooling arrangement that uses a fan. Such “delta/rpm” value pairs can be stored in the memory as a simple look-up-table (LUT) for use by a cooling arrangement controller of the cooling arrangement. Alternatively, the values can be stored as a table, and the cooling arrangement controller might be capable of interpolating between the stored values to determine a more accurate control parameter.

During operation, then, the cooling is simply turned off, and a lamp voltage delta is measured after the same time span used during calibration. The LUT delivers a suitable rpm value or other signal useable by the cooling arrangement controller.

In a further preferred embodiment of the invention, the cooling arrangement controller comprises a memory module for storing such information. For example, delta/rpm value pairs can be stored in a LUT in a memory. This can be updated as required, for example if the system is to be upgraded, or if more precise data has been collected for the lamp type being used.

The cooling can be checked and corrected at any suitable time. For example, the lamp driver might decide, on the basis of lamp operating values that it regularly monitors, that the temperature of the lamp should be checked. The lamp driver can initiate the measurement process, i.e. the deactivation of the cooling, the lamp voltage delta measurement, and the resumption of cooling using the updated cooling control parameters. The activation of the cooling status check can be in response to an internal trigger such as ambient temperature, air pressure or lamp voltage, etc. The activation may equally be carried out at regular intervals, for example after every hundred hours of operation. Of course, it may be preferable to be able to check the cooling status at any time, for example in response to an input from a user, a service technician, or even an external system such as a DVD player. Therefore, in a further preferred embodiment of the invention, the system comprises an activation input for activating the cooling arrangement controller.

The cooling status check can be used not only to adjust the cooling arrangement, but can also be used to provide feedback to a user. For example, a measured lamp voltage delta and associated lamp temperature might indicate that the lamp is liable to fail (for example for a lamp that is still operational although it has exceeded its lifetime). In such a situation, the cooling status check can also provide an appropriate warning signal to the user.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a graph relating coldest spot temperature to halide concentration for a plurality of UHP lamps;

FIG. 2 shows a graph relating change in lamp pressure to halide concentration for a plurality of UHP lamps;

FIG. 3 shows graphs of lamp pressure and lamp voltage values obtained in a method of generating calibration data according to the invention;

FIG. 4 shows a bock diagram of a calibration system according to the invention;

FIG. 5 shows a bock diagram of a projection system according to the invention.

In the drawings, like numbers refer to like objects throughout. Objects in the diagrams are not necessarily drawn to scale.

### DETAILED DESCRIPTION OF THE EMBODIMENTS

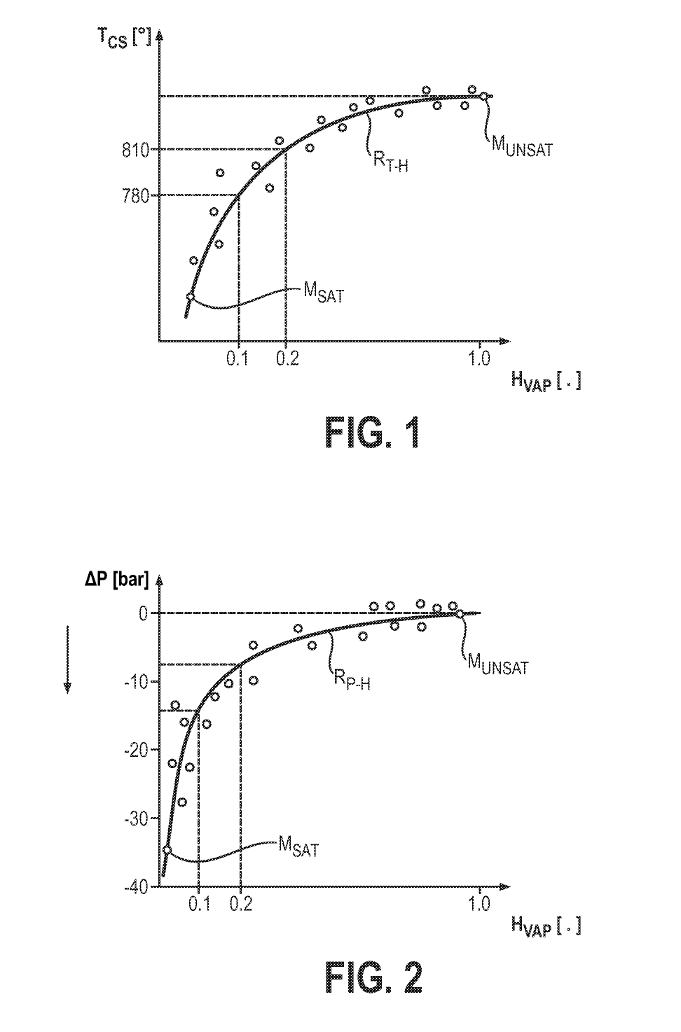

FIGS. 1-3 show graphs of various lamp operating values upon which the method of generating calibration data according to the invention is based.

FIG. 1 shows a graph relating coldest spot temperature T_{CS} (y-axis, degrees Celsius) to halide concentration H_{VAP} (x-axis, dimensionless) for a plurality of UHP lamps. As explained above, the term “halide concentration” is to be understood to mean the concentration of the evaporated metal halide (e.g. a bromide in this case), which is required by the chemical cycle of the lamp. The halide concentration can be measured using any suitable technique, and is expressed as the ratio of evaporated halide to total halide concentration. The coldest spot in a UHP lamp is usually located in the lower region of the lamp since convection results in the upper region of the lamp being the hottest. As the graph shows, a halide concentration within a certain range is associated with a corresponding coldest spot temperature range. The halide concentration for a particular lamp under favourable operating conditions can be identified to lie within a certain range. In the example given, the optimal halide concentration of between 0.1 and 0.2 allows a desired coldest spot temperature range to be identified, in this case between 780° C. and 810° C. This information is generally provided to the manufacturer of a system that will use the lamp. However, it has not been possible to derive a control algorithm from this knowledge, so that the prior art systems cannot always ensure that the halide concentration remains within the optimal range during all operating conditions.

FIG. 2 shows a graph relating change in the mercury pressure ΔP (y-axis, bar) to halide concentration H_{VAP} (x-axis) for the same UHP lamp. Again, to derive this relationship R_{P-H}, the lamp was operated from a point of full evaporation of the mercury (unsaturated mode, indicated by point M_{UNSAT} on the graph), at which point the lamp pressure is highest, and then cooled until it reached a saturated state (indicated by point M_{SAT} on the graph), at which point the lamp pressure is lowest. Using this relationship R_{P-H}, the difference between full pressure (using 0 as a reference) and a lower pressure—i.e. a “pressure delta”—can be used to deduce the halide concentration H_{VAP}. The graph shows that a pressure delta can be deduced from a pressure at unsaturated mode to a pressure at which the halide concentration H_{VAP} is optimal. In the example given, a pressure delta of between 7 and 13 bar relative to 0 is associated with a favourable H_{VAP} value. A similar plot or curve could be obtained for a “degree of blackening” against time, if the blackening is to be used to infer the cooling status of the lamp.

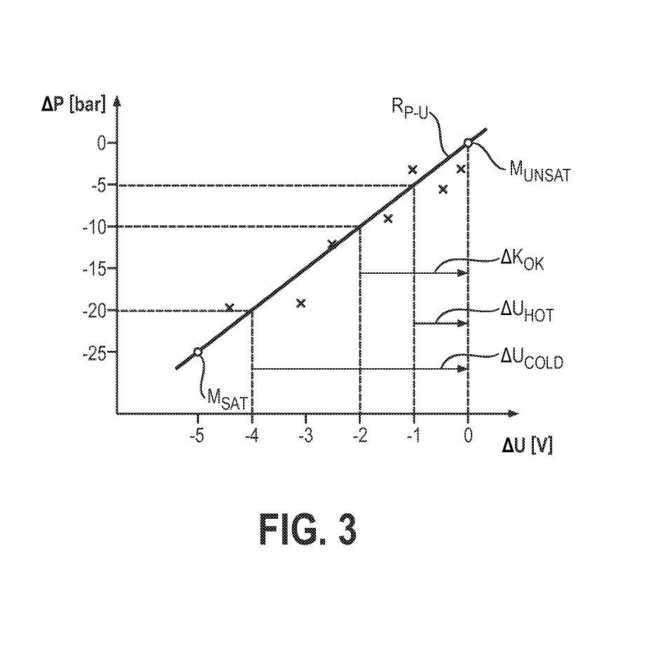

The inventors recognised that this information could be used to determine whether a lamp is being correctly cooled, or whether the cooling should be adjusted in order to return to a favourable halide concentration. FIG. 3 shows a graph R_{V-P} relating a change in lamp pressure ΔP (y-axis, bar) to a change in lamp voltage ΔU (x-axis, V) using values obtained in a method of generating calibration data according to the invention. To derive the relationship R_{P-U}, the lamp was operated from a point of full evaporation of the mercury (unsaturated mode, indicated by point M_{UNSAT} on the graph), at which point the lamp pressure is highest, and then cooled until it reached a saturated state (indicated by point M_{SAT} on the graph), at which point the lamp pressure is lowest. As the lamp pressure drops because of the increased cooling, the lamp voltage also drops. For simplicity, the point M_{UNSAT} on the graph is used as a reference for the drop in lamp voltage and lamp pressure, so that, for example, a measured drop in lamp voltage of about one Volt (−1.0 V) corresponds to a lamp pressure drop of about 7 bar (−7 bar). The inventors recognised that the linear relationship between change in lamp pressure and change in lamp voltage is equally valid in the other direction, i.e. if the lamp cooling is turned off, the resulting increase in lamp pressure and lamp voltage also satisfy this linear relationship R_{P-U}. Therefore, a certain lamp voltage “delta” can be used as a starting point from which to determine the halide concentration (using the relationship R_{P-H}) at the instant at which the cooling was turned off.

If a lamp is being correctly cooled, its lamp voltage will change by a certain amount (e.g. ΔU_{OK}). If a lamp is not being cooled enough, its lamp voltage will change by only a small amount (e.g. ΔU_{HOT}). If a lamp is being cooled too much, its lamp voltage will change by a large amount (e.g. ΔU_{COLD}). In the method of generating calibration data according to the invention, value pairs of lamp voltage delta and cooling arrangement control parameters are stored in memory from which they can be retrieved during normal operation of the lamp. A cooling arrangement control parameter can comprise a value for an increase or decrease in fan rpm, for example.

During normal operation of the lamp, a reference voltage value is recorded. Then, the cooling is turned off. After the same predefined length of time used in calibration, e.g. 30 seconds, the lamp voltage is measured again. The lamp voltage delta is calculated and a corresponding cooling arrangement control parameter can be retrieved from the memory in order to adjust the performance of cooling arrangement.

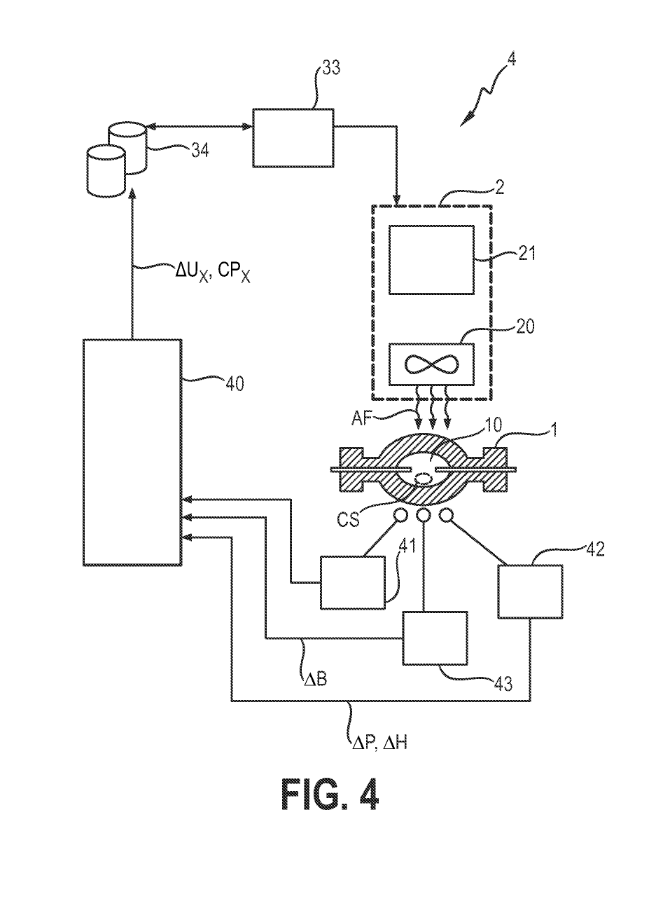

FIG. 4 shows a block diagram, greatly simplified, of a calibration system 4 according to the invention. Here, a UHP gas-discharge lamp 1 is cooled by a cooling arrangement 2, realised to direct a cooling airflow AF over a discharge vessel 10 of the lamp 1 by means of a fan 20. In the calibration setup, a pressure measuring means 42, for example a spectroscope 42, is arranged to measure the concentration of the mercury vapour and/or the halide vapour in the gaseous fill in the discharge vessel. A visual detecting means 43 comprises an optical detecting means for determining an extent of blackening on the walls of the discharge vessel 10. One or both of these measuring devices 42, 43 could be used to obtain measurement data. Optionally, a temperature sensor 41, for example of an infrared temperature measurement device 41 can also be arranged to monitor a temperature in the lamp, for example the coldest spot CS of the lamp 1, usually a region towards the bottom of the discharge vessel. The measuring devices 42, 43 deliver data ΔP, ΔB to an analysis unit 40. The lamp 1 itself is driven by a lamp driver (not shown in the diagram for the sake of clarity), which also supplies lamp voltage values to the analysis unit 40. During calibration, the lamp 1 is driven as described above in FIGS. 1-3 so that the relationships R_{P-H}, R_{P-U} can be established, and cooling arrangement control parameters CPₓ can be associated with lamp voltage deltas ΔU_{X}. Such value pairs ΔU_{X}, CPₓ are stored in a memory 34 accessible to a cooling arrangement controller 33, which is realised in this embodiment to drive a fan controller 21 for the fan 20. Of course, this calibration system 4 can be used to configure the memories 34 of a plurality of projector systems that use that lamp type. For example, data can be collected using a number of lamps of a specific lamp type, and a plurality of value pairs ΔU_{X}, CPₓ can be generated as described above. These values are then loaded or stored in the memory of the cooling arrangement of each projector system.

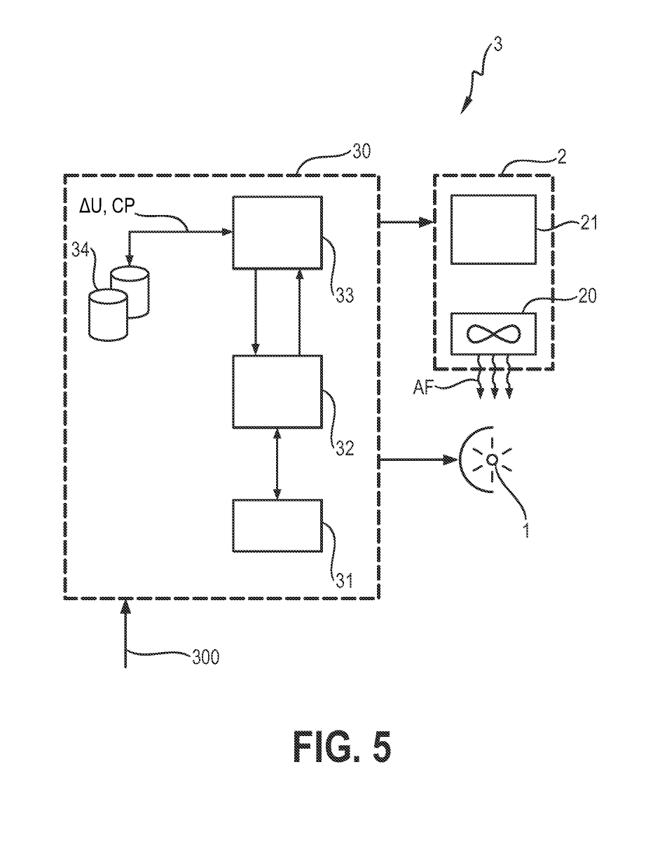

FIG. 5 shows a block diagram of a projection system 3 according to the invention. Here, a UHP lamp 1 is being used to provide a point-like source of white light. The lamp 1 is cooled by a cooling arrangement 2 with a fan 20 to direct a cooling airflow over the lamp 1. The fan 20 is controlled by a fan driver 21, which in turn is controlled by a cooling arrangement controller 33. The lamp 1 is driven by a lamp driver 30, which in this very simplified example comprises a voltage monitor 31 for monitoring the lamp voltage, and a lamp parameter controller 32 for adjusting lamp parameters such as lamp current, lamp power etc., as will be known to the skilled person. A cooling status check can be carried out in response to an activation input 300, after a predetermined time interval, or in response to any other appropriate trigger. The cooling arrangement controller 33 then obtains a lamp voltage measurement value and then instructs the fan controller 21 to turn off the fan 20. After a predefined time, the cooling arrangement controller 33 obtains a further lamp voltage measurement value, and computes the lamp voltage delta AU. This is used to retrieve a corresponding cooling control parameter CP from a memory 34 or LUT 34. The cooling arrangement controller 33 causes the cooling arrangement 2 to resume cooling at a new cooling rate determined by the cooling control parameter CP. This system therefore allows the cooling to be adjusted according to ambient conditions, lamp lifetime, video input, or any other activation input 300, so that the halide concentration in the lamp is maintained at an optimal level. Here, the cooling arrangement controller 33 and memory 34 are shown as part of the driver 30, but could equally well be realised external to the driver 30, for example as an add-on component for upgrading a system. The predefined time span after which the voltage delta is computed can also be stored in the memory 34.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. A “unit” or “module” can comprise one or more units or modules, as appropriate.

1. A method of generating calibration data (ΔUₓ, CP_{X}) for a system comprising a high-pressure gas-discharge lamp and a cooling arrangement for cooling the lamp, which method comprises the steps of
establishing a correlation (R_{P-U}) between a lamp operating parameter delta (ΔU) and a lamp cooling status parameter delta (ΔP, ΔB); and
associating a cooling arrangement control parameter (CP, CP_{X}) with a lamp operating parameter delta (ΔU) on the basis of the established correlation (R_{P-U}).

2. A method according to claim 1, comprising the step of establishing a relationship (R_{P-H}) between a lamp cooling status parameter (ΔP, ΔB) and the lamp cooling status, and wherein the step of associating a cooling arrangement control parameter (CP, CP_{X}) with a lamp operating parameter delta (ΔU) is performed on the basis of the established relationship (R_{P-H}).

3. A method according to claim 2, wherein the lamp cooling status parameter (ΔP) comprises a spectroscopic pressure measurement (ΔP) relating to a pressure in the interior of a discharge vessel of the lamp.

4. A method according to claim 2, wherein the lamp cooling status parameter (ΔB) comprises a value relating to an extent of discoloration on the interior of a discharge vessel of the lamp.

5. A method according to claim 1, wherein the correlation (R_{P-U}) between a lamp operating parameter delta (ΔU) and a lamp cooling status parameter delta (ΔP, ΔB) is determined during operation of the lamp at a specific cooling condition.

6. A method according to claim 5, wherein the specific cooling condition comprises a reduction or cessation of lamp cooling.

7. A method according to claim 6, wherein a lamp operating parameter delta (ΔU) and a corresponding lamp cooling status parameter delta (ΔP, ΔB) are determined when a predefined time has elapsed after reduction or cessation of the lamp cooling.

8. A method according to claim 7, wherein the predefined time span comprises at most 60 s, more preferably at most 40 s, most preferably at most 20 s.

9. A method according to claim 8, wherein the lamp operating parameter comprises the lamp voltage.

10. A method of calibrating a cooling arrangement of a system comprising a high-pressure gas-discharge lamp and a cooling arrangement for cooling the lamp, which method comprises the steps of
determining a number of lamp operating parameter deltas (ΔUₓ) and associated cooling arrangement control parameters (CPₓ) for that lamp (1) using the method of generating calibration data according to claim 1; and
storing the lamp operating parameter deltas (ΔUₓ) and associated cooling arrangement control parameters (CPₓ) in a memory of the cooling arrangement.

11. A method of controlling a cooling arrangement in a system comprising a high-pressure gas discharge lamp, which cooling arrangement is calibrated using the calibration method according to claim 10, which method comprises the steps of
monitoring a lamp operating parameter during operation of the lamp at a first cooling level;
reducing or interrupting the cooling and subsequently measuring a lamp operating parameter delta (ΔU);
retrieving a control parameter for the cooling arrangement associated with the lamp operating parameter delta (ΔU); and
controlling the cooling arrangement according to the control parameter.

12. A method according to claim 10, wherein the lamp operating parameter delta (ΔU) is measured when a predefined time has elapsed after reduction or cessation of the lamp cooling, which predefined time span corresponds to the predefined time span used in the calibration method.

13. A system (4) comprising
a high-pressure gas discharge lamp;
a cooling arrangement for cooling the lamp, which cooling arrangement is calibrated using the method according to claim 10; and
a cooling arrangement controller (33) for controlling the cooling arrangement.

14. A system according to claim 13, comprising an activation input for activating the cooling arrangement controller.

15. A system according to claim 13, wherein the system is a projection system.
